(19) United States
(12) Patent Application Publication
(10) Pub. No.: US 2026/0299282 A1
(43) Pub. Date: Oct. 1, 2026

(54) WAVELENGTH VARIABLE INTERFERENCE FILTER

(71) Applicant: SEIKO EPSON CORPORATION, TOKYO (JP)

(72) Inventor: Kengo TAKAGI, SHIOJIRI-SHI (JP)

(21) Appl. No.: 19/629,232

(22) Filed: Mar. 26, 2026

(30) Foreign Application Priority Data
Mar. 26, 2025 (JP) 2025-051241

(51) Int. Cl. G02B 26/00

(52) U.S. Cl. CPC G02B 26/001

(57) ABSTRACT

A wavelength variable interference filter includes a first board including a first reflective film and a first bonding region positioned around the first reflective film and a second board including a second reflective film that opposes the first reflective film in a first direction therebetween and a second bonding region that is positioned around the second reflective film, wherein the first bonding region has a first flat and a first taper inclined with respect to the first flat, the second bonding region has a second flat opposing the first flat in the first direction and a second taper inclined with respect to the second flat, and the first board and the second board are bonded to each other by bonding at least the first flat and the second flat to each other in a state where the first taper and the second taper are in contact with each other.

The present application is based on, and claims priority from JP Application Ser. No. 2025-051241, filed Mar. 26, 2025, the disclosure of which is hereby incorporated by reference herein in its entirety.

### BACKGROUND

### 1. Technical Field

The present disclosure relates to a wavelength variable interference filter.

### 2. Related Art

A wavelength variable interference filter including a first board and a second board opposing the first board is known (for example, JP-A-2022-40198). In the wavelength variable interference filter, the first board has a first reflective film, and the second board has a second reflective film opposing the first reflective film via a gap. In the related art, in the wavelength variable interference filter, the wavelength region of the light to be transmitted is changed by adjusting the dimension of the gap.

In the wavelength variable interference filter, the first board and the second board are bonded to each other in flats positioned around the first reflective film and the second reflective film. In a case where the first board and the second board are bonded to each other at the flats, a load is applied at the time of bonding and, by this, a positional deviation may occur between the first board and the second board in a direction along the flats. In a case where positional deviation occurs, a positional deviation occurs between an element such as the first reflective film included in the first board and an element such as the second reflective film included in the second board, and a problem such as a failure to accurately transmit light having a desired wavelength may occur.

### SUMMARY

According to an aspect of the present disclosure, a wavelength variable interference filter is provided.

The wavelength variable interference filter includes a first board including a first reflective film and a first bonding region positioned around the first reflective film and a second board including a second reflective film that opposes the first reflective film in a first direction via a gap therebetween and a second bonding region that is positioned around the second reflective film, wherein the first bonding region has a first flat and a first taper inclined with respect to the first flat, the second bonding region has a second flat that opposes the first flat in the first direction and a second taper that is inclined with respect to the second flat, and the first board and the second board are bonded to each other by bonding at least the first flat and the second flat to each other in a state where the first taper and the second taper are in contact with each other.

### BRIEF DESCRIPTION OF THE DRAWINGS

FIG. 1 is a schematic diagram illustrating a spectroscopic device having a wavelength variable interference filter according to a first embodiment.

FIG. 2 is a cross-sectional view taken along line II-II in FIG. 1.

FIG. 3 is a diagram for explaining an inclination angle of a first taper and a second taper.

FIG. 4 is a diagram for explaining a wavelength variable interference filter according to a second embodiment.

FIG. 5 is a diagram illustrating a wavelength variable interference filter according to another embodiment 1.

FIG. 6 is a diagram illustrating a wavelength variable interference filter according to another embodiment 2.

### DESCRIPTION OF EMBODIMENTS

### A. First Embodiment

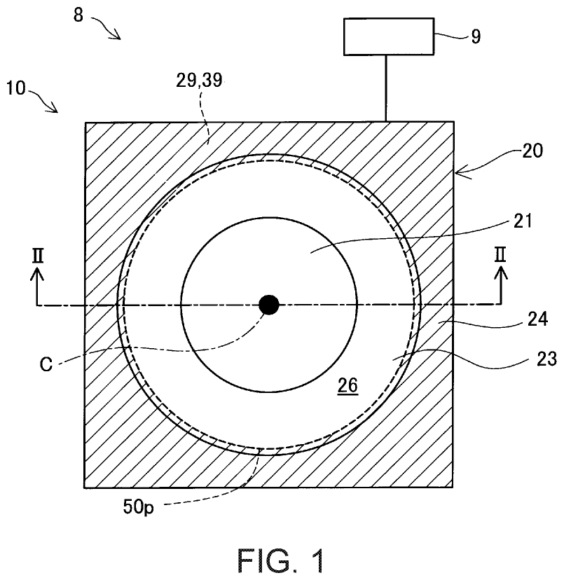

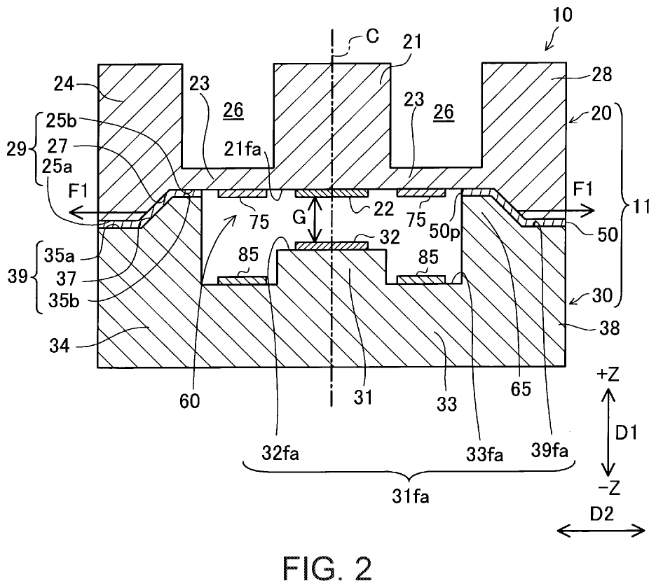

FIG. 1 is a schematic diagram illustrating a spectroscopic device 8 having a wavelength variable interference filter 10 according to a first embodiment. FIG. 2 is a cross-sectional view taken along line II-II in FIG. 1. The spectroscopic device 8 adjusts the dimension of a gap G (to be described later) of the wavelength variable interference filter 10, thereby transmitting light having a target wavelength from light having components of various wavelengths incident on the wavelength variable interference filter 10. FIG. 2 illustrates a reference state in which a voltage is not applied between a first drive electrode 75 and a second drive electrode 85 (to be described later) of the wavelength variable interference filter 10 and the dimension of the gap G is a reference dimension. Hereinafter, in a case where the configuration of the wavelength variable interference filter 10 is described, it is assumed that it is in the reference state.

As illustrated in FIG. 1, the spectroscopic device 8 includes a control device 9 and the wavelength variable interference filter 10. The control device 9 controls the operation of the wavelength variable interference filter 10. The wavelength variable interference filter 10 is an etalon. The wavelength variable interference filter 10 is an optical member having a substantially rectangular parallelepiped shape. As illustrated in FIG. 2, the wavelength variable interference filter 10 includes a first board 20 as a movable board and a second board 30 as a fixed board opposing the first board 20 in a first direction D1. The first board 20 and the second board 30 constitute a board pair 11. In the first direction D1, a direction from the second board 30 toward the first board 20 is a +Z direction, and a direction from the first board 20 toward the second board 30 is a −Z direction.

The first board 20 includes a first main body 28, a first reflective film 22, the first drive electrode 75, and a first bonding region 29. The first main body 28 is a main body that forms the outer shape of the first board 20. The first main body 28 is made of a material that transmits light, such as various types of glass or quartz crystal. The first main body 28 has a first main surface 21fa opposing the second board 30 and a recess 26 formed on the opposite side of the first main surface 21fa. As illustrated in FIG. 1, the recess 26 has a constant width and has an annular shape with a central axis C as the center. The direction along the central axis C is a first direction D1. As illustrated in FIG. 2, the first main body 28 of the first board 20 includes a movable section 21, a support 23, and a first outer peripheral section 24. The movable section 21, the support 23, and the first outer peripheral section 24 each have the first main surface 21fa as a bottom surface. The movable section 21 is a section surrounded by the annular recess 26. The support 23 is connected to the movable section 21. The support 23 is a bottom wall of the recess 26 and has a thickness in the first direction D1 that is smaller than that of the movable section 21. The first outer peripheral section 24 is connected to the first main body 28. The first outer peripheral section 24 is positioned radially outward from the movable section 21 with the central axis C as the center. The first outer peripheral section 24 has a thickness in the first direction D1 larger than that of the movable section 21. The support 23 is positioned between the first reflective film 22 and the first bonding region 29 in plan view as viewed from a direction along the first direction D1. The support 23 is elastically deformed to displace the first reflective film 22 in the first direction D1, thereby changing the size of the gap G.

In plan view, the first reflective film 22 is formed in a region of the first main surface 21fa where the movable section 21 is positioned. The first reflective film 22 is a substantially circular film. The first reflective film 22 is a film having a reflection function and a transmission function. The first reflective film 22 is, for example, a metal film such as Ag or a conductive alloy film such as an Ag alloy.

The first drive electrode 75 is disposed on the first main surface 21fa so as to surround the first reflective film 22 with the central axis C as the center. In the present embodiment, the first drive electrode 75 is disposed at position overlapping the support 23 on the first main surface 21fa in plan view. The first drive electrode 75 has a constant width and has an annular shape with the central axis C as the center.

The first bonding region 29 is positioned further than the first drive electrode 75 to the outer side in the radial direction, with the central axis C as the center. The first bonding region 29 is a region formed on the first main surface 21fa. As illustrated in FIG. 1, the first bonding region 29 is a region indicated by single hatching, and is positioned around the first reflective film 22 and the first drive electrode 75. Specifically, in plan view, the first bonding region 29 is formed so as to surround the first reflective film 22 and the first drive electrode 75 with the central axis C as the center.

As illustrated in FIG. 2, the first bonding region 29 has a first outer flat 25a, a first taper 27, and a first inner flat 25b. The first outer flat 25a and the first inner flat 25b are each a first flat. The first inner flat 25b is positioned at the same height position as the height position in the first direction D1 where the first reflective film 22 and the first drive electrode 75 are positioned. The first inner flat 25b forms a plane orthogonal to the first direction D1. The first inner flat 25b has an annular shape with a constant thickness.

The first outer flat 25a is positioned on the −Z direction side of the first inner flat 25b in the first direction D1. The first outer flat 25a forms a plane orthogonal to the first direction D1.

The first taper 27 is a surface connecting the first inner flat 25b and the first outer flat 25a. As illustrated in FIG. 2, the first taper 27 is inclined with respect to the first outer flat 25a and the first inner flat 25b in a predetermined cross section passing through the central axis C and parallel to the first direction D1. That is, in the predetermined cross section, the first taper 27 is inclined so as to be positioned on the +Z direction side, which is a direction separating away from the second board 30 in the first direction D1, as the first taper 27 extends toward the first reflective film 22.

As illustrated in FIG. 2, the second board 30 has a second main body 38, a second reflective film 32, the second drive electrode 85, and a second bonding region 39. The second main body 38 is a main body that forms the outer shape of the second board 30. The second main body 38 is made of a material that transmits light, such as various types of glass or quartz crystal.

The second main body 38 has a reflection film installation section 31, an electrode installation section 33, a second outer peripheral section 34, and a second main surface 31fa. The reflection film installation section 31 opposes the first reflective film 22 in the first direction D1. The surface of the reflection film installation section 31 that opposes the first reflective film 22 is an inner surface 32fa that constitutes the second main surface 31fa. The second reflective film 32 is disposed on the inner surface 32fa. The electrode installation section 33 is disposed so as to surround the reflection film installation section 31. The electrode installation section 33 opposes the first drive electrode 75 in the first direction D1. The electrode installation section 33 is connected to the reflection film installation section 31 via a step. The surface of the electrode installation section 33 opposing the first drive electrode 75 is an intermediate surface 33fa constituting the second main surface 31fa. The second drive electrode 85 is disposed on the intermediate surface 33fa. The second outer peripheral section 34 is connected to the electrode installation section 33 via a step. The second outer peripheral section 34 opposes the first outer peripheral section 24 in the first direction D1. The surface of the second outer peripheral section 34 opposing the first outer peripheral section 24 is an outer surface 39fa constituting the second main surface 31fa. In the first direction D1, the outer surface 39fa is positioned closer to the first board 20 than the inner surface 32fa and the intermediate surface 33fa.

The second reflective film 32 is disposed on the inner surface 32fa at a position opposing the first reflective film 22 of the first direction D1. The second reflective film 32 is a substantially circular film. The second reflective film 32 is a film having a reflection function and a transmission function. The second reflective film 32 is, for example, a metal film such as Ag or a conductive alloy film such as an Ag alloy. The second reflective film 32 opposes the first reflective film 22 in the first direction D1 with the gap G interposed therebetween.

The second drive electrode 85 is disposed on the intermediate surface 33fa of the electrode installation section 33 so as to surround the second reflective film 32 with the central axis C as the center. The second drive electrode 85 oppose the first drive electrode 75 in the first direction D1. The second drive electrode 85 has a constant width and has an annular shape with the central axis C as the center.

The second bonding region 39 is positioned on the outer side in the radial direction with the central axis C as the center from the second drive electrode 85. The second bonding region 39 is a region formed on the outer surface 39fa among the second main surface 31fa. As illustrated in FIG. 1, the second bonding region 39 overlaps the first bonding region 29 in plan view, and is a region indicated by single hatching. The second bonding region 39 is positioned around the second reflective film 32 and the second drive electrode 85. Specifically, in plan view, the second bonding region 39 is formed so as to surround the second reflective film 32 and the second drive electrode 85 with the central axis C as the center.

As illustrated in FIG. 2, the second bonding region 39 has a second outer flat 35a, a second taper 37, and a second inner flat 35b. The second outer flat 35a and the second inner flat 35b are each a second flat. The second inner flat 35b is positioned closer to the first board 20 than the height position where the second reflective film 32 and the second drive electrode 85 are positioned in the first direction D1. The second inner flat 35b forms a plane orthogonal to the first direction D1. The second inner flat 35b has an annular shape with a constant thickness. The second inner flat 35b opposes the first inner flat 25b in the first direction D1.

The second outer flat 35a is positioned on the-Z direction side of the second inner flat 35b in the first direction D1. The second outer flat 35a forms a plane orthogonal to the first direction D1. The second outer flat 35a opposes the first outer flat 25a in the first direction D1.

The second taper 37 is a surface connecting the second inner flat 35b and the second outer flat 35a. The second taper 37 opposes the first taper 27 in the first direction D1. As illustrated in FIG. 2, the second taper 37 is inclined with respect to the second outer flat 35a and the second inner flat 35b in the predetermined cross section. That is, in the predetermined cross section, the second taper 37 is inclined so as to be positioned on the +Z direction side, which is a direction approaching the first board 20 in the first direction D1, as the second taper 37 extends toward the second reflective film 32.

In FIG. 1 and FIG. 2, an inner circumferential side end section of the first bonding region 29 and the second bonding region 39 on the central axis C side are also referred to as an inner circumferential end section 50p to facilitate understanding.

As illustrated in FIG. 2, the wavelength variable interference filter 10 further includes a bonding film 50 that bonds the first main body 28 of the first board 20 and the second main body 38 of the second board 30. The bonding film 50 is formed between the first bonding region 29 and the second bonding region 39 so as to surround the central axis C, thereby bonding the first main body 28 and the second main body 38. In the present embodiment, the bonding film 50 is formed between the first inner flat 25b and the second inner flat 35b, between the first taper 27 and the second taper 37, and between the first outer flat 25a and the second inner flat 35b. The bonding film 50 is formed of a plasma polymerized film or the like containing siloxane as a main component. In the present embodiment, the first bonding region 29 and the second bonding region 39 are activated by plasma to form a plasma polymerized film, and the first bonding region 29 and the second bonding region 39 are bonded to each other, whereby the first board 20 and the second board 30 are bonded to each other. That is, the bonding film 50 can be said to constitute a part of the first main body 28 and the second main body 38.

As a bonding method, for example, the second board 30 is placed on a horizontal table, and the first board 20 is pressed against the second board 30 from the +Z direction side to the −Z direction side with a predetermined force for a predetermined time, whereby the first board 20 and the second board 30 are bonded to each other. The second taper 37 applies an external force F1 to the first taper 27, pulling it radially outward with the central axis C as the center. By this, it is possible to suppress the support 23 from being bent or deformed when the first board 20 and the second board 30 are bonded to each other or in the reference state. Therefore, in the reference state, it is possible to suppress the position or the posture of the first reflective film 22 from deviating from the designed value and, by this, it is possible to transmit light having the target wavelength according to the potential difference from the wavelength variable interference filter 10 with high accuracy.

As described above, in the wavelength variable interference filter 10, while the first taper 27 and the second taper 37 are in contact with each other, the first inner flat 25b and the second inner flat 35b are bonded to each other, the first outer flat 25a and the second outer flat 35a are bonded to each other, and the first taper 27 and the second taper 37 are bonded together, thereby bonding the first board 20 and the second board 30 to each other.

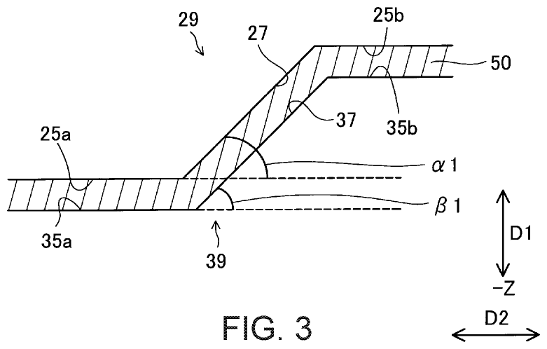

FIG. 3 is a diagram for explaining the inclination angles of the first taper 27 and the second taper 37. In the predetermined cross section, the inclination angle of the first taper 27 is an angle α1. In the predetermined cross section, the inclination angle of the second taper 37 is an angle β1. In the predetermined cross section, the angle α1 is an angle formed by the first taper 27 and a second direction D2, which is orthogonal to the first direction D1. In the predetermined cross section, the angle β1 is an angle formed by the second direction D2 and the second taper 37. In the present embodiment, the angle α1 and the angle β1 are the same angle, but may be different angles in other embodiments. The angle α1 is desirably 45° or more and less than 90°. The angle β1 is desirably 45° or more and less than 90°. By setting the angle α1 and the angle β1 in the range of 45° or more and less than 90°, respectively, the external force F1 directed in the outward direction can be efficiently applied to the first taper 27 by the second taper 37. The first taper 27 and the second taper 37 are meshed with each other, and thus it is possible to suppress sliding along the contact surfaces of the first taper 27 and the second taper 37.

In the wavelength variable interference filter 10 according to the first embodiment, as illustrated in FIG. 2, it can be said that the first main body 28 has a recess 60 on the second main body 38 side. A bottom surface of the recess 60 is formed by a portion of the first main surface 21fa. The first reflective film 22 and the first drive electrode 75 are disposed on the bottom surface of the recess 60. A side surface of the recess 60 is the first taper 27. The recess 60 is formed by processing the first main body 28 by dry etching, wet etching, or the like. It can also be said that the second main body 38 has a protrusion 65 accommodated in the recess 60 on the first main body 28 side. The protrusion 65 is a part of the second outer peripheral section 34, and forms the second inner flat 35b and the second taper 37. In the wavelength variable interference filter 10, the first main body 28 and the second main body 38 are bonded to each other in a state where the protrusion 65 is inserted into the recess 26.

According to the first embodiment, as illustrated in FIG. 2, the wavelength variable interference filter 10 has the first taper 27 and the second taper 37. By this, when the first board 20 and the second board 30 are bonded, the first taper 27 and the second taper 37 contact each other and, by this, the first board 20 and the second board 30 can be aligned. Therefore, positional deviation of the second board 30 with respect to the first board 20 in the direction along the flat such as the first outer flat 25a or the second outer flat 35a, that is, in the second direction D2 is suppressed. In other words, when the first board 20 and the second board 30 are bonded to each other, the protrusion 65, of which the second taper 37 forms a side wall, is fitted into the recess 60, of which the first taper 27 forms the sidewall, and, by this, it is possible to easily perform the alignment between the first board 20 and the second board 30. Even after the wavelength variable interference filter 10 is manufactured, the first taper 27 and the second taper 37 are in contact with each other and, by this, even when an external force such as an impact is applied to the wavelength variable interference filter 10, it is possible to suppress positional deviation between the first board 20 and the second board 30 in the second direction D2. By suppressing positional deviation between the first board 20 and the second board 30, it is possible to suppress positional deviation between elements such as the first reflective film 22 and the first drive electrode 75 of the first board 20 and corresponding elements such as the second reflective film 32 and the second drive electrode 85 of the second board 30. By this, light of the target wavelength corresponding to the potential difference between the first drive electrode 75 and the second drive electrode 85 can be transmitted from the wavelength variable interference filter 10 with high accuracy.

According to the above first embodiment, as illustrated in FIG. 1 and FIG. 2, the first bonding region 29 is formed so as to surround the first reflective film 22 and the first drive electrode 75 with the central axis C as the center. The second bonding region 39 is formed so as to surround the second reflective film 32 and the second drive electrode 85 with the central axis C as the center. By this, since the bonding between the first board 20 and the second board 30 can be made stronger, the relative positional deviation between the first reflective film 22 and the second reflective film 32 and the relative positional deviation between the first drive electrode 75 and the second drive electrode 85 in the reference state can be further suppressed.

Note that in the above first embodiment, the first taper 27 and the second taper 37 may not be bonded, and at least one of the set of the first inner flat 25b and the second inner flat 35b and the set of the first outer flat 25a and the second outer flat 35a may be bonded. In this case, when the first bonding region 29 and the second bonding region 39 are bonded, the first taper 27 and the second taper 37 are not activated by plasma. By this, even when the first taper 27 and the second taper are in contact with each other before the first flat and the second flat at the time of bonding, the first board 20 can be easily moved relative to the second board 30 in order to bring the first flat and the second flat into contact with each other in a state where the first taper 27 and the second taper 37 are in contact with each other. By this, the alignment of the first board 20 and the second board 30 can be performed more easily.

### B. Second Embodiment

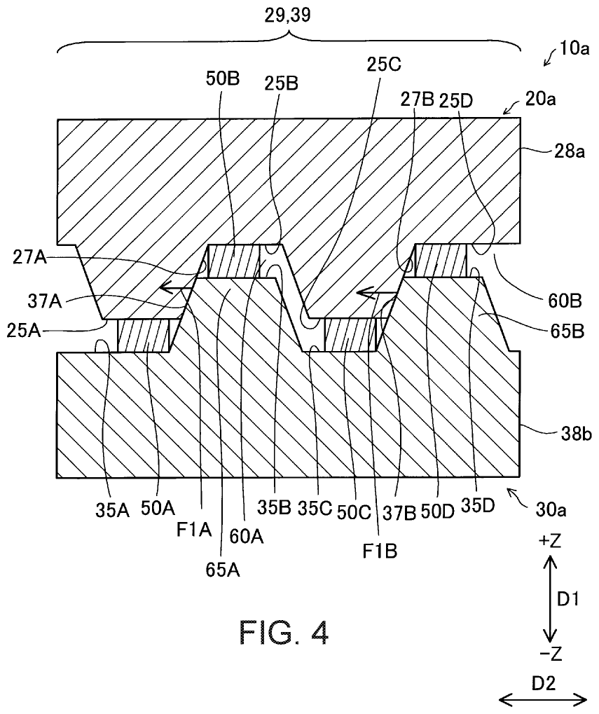

FIG. 4 is a diagram for explaining a wavelength variable interference filter 10a according to a second embodiment. FIG. 4 is a cross-section corresponding to FIG. 2, and illustrates the left half of the first bonding region 29 and the second bonding region 39 that are line-symmetric in a predetermined cross-section.

The difference between the wavelength variable interference filter 10a of the second embodiment and the wavelength variable interference filter 10 of the first embodiment is the number of the first tapers, the second tapers, the first flats, and the second flats, and the point that the first tapers and the second tapers are not bonded. Since the other configurations of the second embodiment are the same as those of the first embodiment, the same reference symbols are given to the same configurations, and the description thereof will be omitted as appropriate.

In a first main body 28a of a first board 20a, the first flat is four sections of a first outermost flat 25A, a first outer flat 25B, a first inner flat 25C, and a first innermost flat 25D. In a second main body 38a of a second board 30a, the second flat is four portions of a second outermost flat 35A, a second outer flat 35B, a second inner flat 35C, and a second innermost flat 35D. In the first main body 28a, the first taper is two sections of a first outer taper 27A and a first inner taper 27B. In a second main body 38b, the second taper is two sections of a second outer taper 37A and a second inner taper 37B.

In the first flat, the first innermost flat 25D, the first inner flat 25C, the first outer flat 25B, and the first outermost flat 25A are positioned in this order from the inside to the outside with the central axis C illustrated in FIG. 2 as the center. In the second flat, the second innermost flat 35D, the second inner flat 35C, the second outer flat 35B, and the second outermost flat 35A are positioned in this order from the inside to the outside with the central axis C illustrated in FIG. 2 as the center.

As illustrated in FIG. 4, the first outermost flat 25A, the first outer flat 25B, the first inner flat 25C, the first innermost flat 25D, the second outermost flat 35A, the second outer flat 35B, the second inner flat 35C, and the second innermost flat 35D each form a plane orthogonal to the first direction D1. The first outermost flat 25A and the second outermost flat 35A oppose each other in the first direction D1 and are bonded by a first bonding film 50A as a bonding film. The first outer flat 25B and the second outer flat 35B oppose each other in the first direction D1 and are bonded by a second bonding film 50B as a bonding film. The first inner flat 25C and the second inner flat 35C oppose each other in the first direction D1 and are bonded by a third bonding film 50C as a bonding film. The first innermost flat 25D and the second innermost flat 35D oppose each other in the first direction D1 and are bonded by a fourth bonding film 50D as a bonding film. In the present embodiment, the wavelength variable interference filter 10a is bonded only by the first flat and the second flat, and is not bonded by the other portions.

The first outer taper 27A connects the first outermost flat 25A and the first outer flat 25B. The first inner taper 27B connects the first inner flat 25C and the first innermost flat 25D. In the predetermined cross section, the first outer taper 27A and the first inner taper 27B are each inclined with respect to the first flat. The first outer taper 27A and the first inner taper 27B incline so as to be positioned on the +Z direction side, which is a direction away from the second board 30a in the first direction D1, as the first outer taper 27A and the first inner taper 27B extend toward the first reflective film 22.

The second outer taper 37A connects the second outermost flat 35A and the second outer flat 35B. The second inner taper 37B connects the second inner flat 35C and the second innermost flat 35D. In the predetermined cross section, the second outer taper 37A and the second inner taper 37B are inclined so as to be positioned on the +Z direction side, which is a direction approaching the first board 20a in the first direction D1, as the second outer taper 37A and the second inner taper 37B extend toward the second reflective film 32.

The first outer taper 27A and the second outer taper 37A are in contact with each other without the bonding film interposed therebetween. The first inner taper 27B and the second inner taper 37B are in contact with each other without the bonding film 50 interposed therebetween.

An external force F1A is applied by the second outer taper 37A to the first outer taper 27A in the radially outward direction with the central axis C as the center. An external force F1B is applied by the second inner taper 37B to the first inner taper 27B in the radially outward direction with the central axis C as the center. By this, similarly to the first embodiment, since it is possible to suppress the support 23 from being bent or deformed in the reference state and, by this, it is possible to transmit light having the target wavelength according to the potential difference from the wavelength variable interference filter 10a with high accuracy. Note that in other embodiments, the set of the second outer taper 37A and the first outer taper 27A, and the set of the second inner taper 37B and the first inner taper 27B may be in contact with each other in at least one of the sets.

The inclination angles of the first outer taper 27A, the first inner taper 27B, the second outer taper 37A, and the second inner taper 37B may be equal to or different from each other. In the present embodiment, similarly to the first embodiment, the inclination angles of the first outer taper 27A, the first inner taper 27B, the second outer taper 37A, and the second inner taper 37B are the same, and are desirably 45° or more and less than 90°.

In the second embodiment, it can also be said that the first board 20 has a plurality of recesses in the first bonding region 29, and the second board 30 has a plurality of protrusions in the second bonding region 39. As illustrated in FIG. 4, the plurality of recesses include a first recess 60A and a second recess 60B. The first recess 60A has the first outer flat 25B as a bottom section and includes the first outer taper 27A as a part of a sidewall. The second recess 60B has the first innermost flat 25D as a bottom section and includes the first inner taper 27B as a part of a sidewall. The plurality of protrusions include a first protrusion 65A and a second protrusion 65B. The first protrusion 65A has the second outer flat 35B as a top section and includes the second outer taper 37A as a part of a sidewall. The second protrusion 65B has the second innermost flat 35D as a top section and includes the second inner taper 37B as a part of a sidewall.

According to the second embodiment, the same effects are achieved in that the second embodiment has the same configuration as the above first embodiment. According to the second embodiment, the wavelength variable interference filter 10a includes the plurality of first tapers and the plurality of second tapers. By this, since positional deviation between the first board 20 and the second board 30 can be suppressed at a plurality of positions, such as the contact between the first outer taper 27A and the second outer taper 37A and the contact between the first inner taper 27B and the second inner taper 37B, positional deviation can be more reliably suppressed. In other words, at the time of bonding, the first protrusion 65A is fitted to the first recess 60A, and the second protrusion 65B is fitted to the second recess 60B, so that positional deviation of the second board 30 with respect to the first board 20 can be suppressed at the plurality of positions.

Note that in the second embodiment, the first outer taper 27A and the second outer taper 37A may be bonded to each other, or the first inner taper 27B and the second inner taper 37B may be bonded to each other.

### C. Other Embodiments

### C-1. Other Embodiment 1

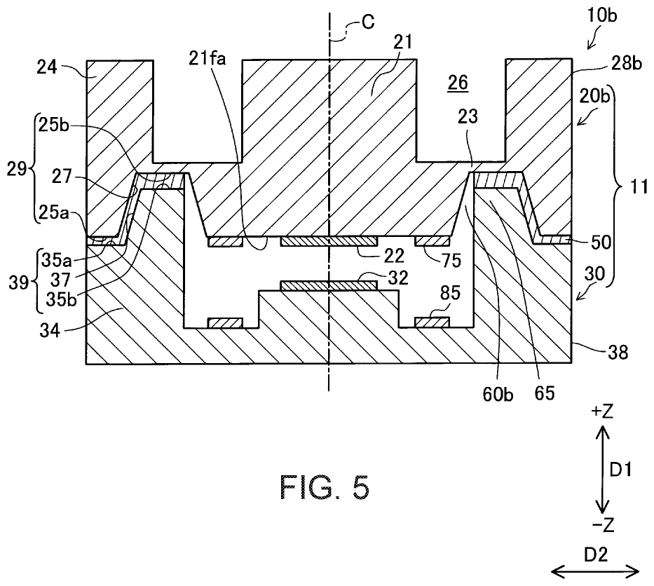

FIG. 5 is a diagram illustrating a wavelength variable interference filter 10b according to another embodiment 1. FIG. 5 is a diagram corresponding to FIG. 2. The difference between the wavelength variable interference filter 10b and the wavelength variable interference filter 10 illustrated in FIG. 2 is the shape of a recess 60b. Since the other configurations are the same as those of the wavelength variable interference filter 10 illustrated in FIG. 2, the same reference symbols are given to the same configurations, and the description thereof will be omitted as appropriate.

A first main body 28b of a first board 20b of the wavelength variable interference filter 10b illustrated in FIG. 5 has the recess 60b on the second board 30 side. The recess 60b is formed radially outside the first reflective film 22 and the first drive electrode 75 with the central axis C as the center. The recess 60b extends annularly with the central axis C as the center. In the wavelength variable interference filter 10b, among the first main body 28b, the region where the first reflective film 22 and the first drive electrode 75 are positioned is not formed with a recess by etching, and the region around the first reflective film 22 and the first drive electrode 75 is formed with the recess 60b by etching. A bottom section of the recess 60b forms the first inner flat 25b, and a side section of the recess 60b forms the first taper 27.

According to the other embodiment 1, the region of the first board 20b where the first reflective film 22 and the first drive electrode 75 are positioned is not processed by etching. By this, it is possible to suppress the optical characteristics of the movable section 21 in which the first reflective film 22 is disposed in the first main body 28b from being unintentionally changed.

### C-2. Other Embodiment 2

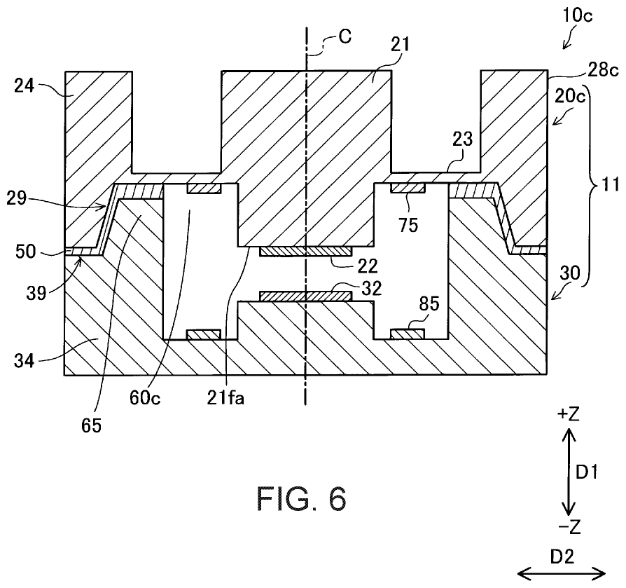

FIG. 6 is a diagram illustrating a wavelength variable interference filter 10c according to another embodiment 2. FIG. 5 is a diagram corresponding to FIG. 2. The difference between the wavelength variable interference filter 10c and the wavelength variable interference filter 10 illustrated in FIG. 2 is the shape of a recess 60c. Since the other configurations are the same as those of the wavelength variable interference filter 10 illustrated in FIG. 2, the same reference symbols are given to the same configurations, and the description thereof will be omitted as appropriate.

The first main body 28c of a first board 20c had in the wavelength variable interference filter 10c illustrated in FIG. 6 has the recess 60c on the second board 30 side. The recess 60c is formed on the radially outer side of the first reflective film 22 with the central axis C as the center. The recess 60c extends annularly with the central axis C as the center. As described above, in the wavelength variable interference filter 10c, the region among the first main body 28c where the first reflective film 22 is positioned is not formed with a recess by etching, and the region around the first reflective film 22 is formed with the recess 60c by etching. A bottom section of the recess 60c forms a portion where the first drive electrode 75 are disposed and the first inner flat 25b, and a side section of the recess 60c forms the first taper 27.

According to the second other embodiment, similarly to the other embodiment 1, the region of the first board 20c where the first reflective film 22 is positioned is not processed by etching. By this, it is possible to suppress the optical characteristics of the movable section 21 in which the first reflective film 22 is disposed in the first main body 28c from being unintentionally changed.

### D. Other Forms

The present disclosure is not limited to the embodiments described above, but can be realized in various forms without departing from the scope of the present disclosure. For example, the present disclosure can also be realized by the following forms. The technical features in the above embodiments that correspond to the technical features in each aspect described below can be replaced or combined as appropriate to solve some or all of the issues of this disclosure or to achieve some or all of the effects of this disclosure. Unless the technical features are described as essential in the present specification, the technical features can be appropriately deleted.

(1) According to an aspect of the present disclosure, a wavelength variable interference filter is provided.

The wavelength variable interference filter includes a first board including a first reflective film and a first bonding region positioned around the first reflective film and a second board including a second reflective film that opposes the first reflective film in a first direction via a gap therebetween and a second bonding region that is positioned around the second reflective film, wherein the first bonding region has a first flat and a first taper inclined with respect to the first flat, the second bonding region has a second flat that opposes the first flat in the first direction and a second taper that is inclined with respect to the second flat, and the first board and the second board are bonded to each other by bonding at least the first flat and the second flat to each other in a state where the first taper and the second taper are in contact with each other.

According to the aspect described above, by bringing the first taper and the second taper into contact with each other, it is possible to suppress positional deviation of the second board with respect to the first board in the direction along the first flat and the second flat.

(2) The above aspect may be such that in the first bonding region and the second bonding region, the first taper and the second taper are not bonded to each other, and the first flat and the second flat are bonded to each other.

According to the aspect, since the first taper and the second taper are not bonded to each other when the first bonding region and the second bonding region are bonded to each other, it is possible to easily perform the alignment of the first board and the second board.

(3) The above aspect may be such that the first bonding region is formed so as to surround the first reflective film and the second bonding region is formed so as to surround the second reflective film.

According to the aspect described above, it is possible to suppress the relative positional deviation between the first reflective film and the second reflective film.

(4) The above aspect may be such that the first board further has a support that is positioned between the first reflective film and the first bonding region, and that elastically deforms to displace the first reflective film and change the size of the gap, the first taper is inclined so as to be positioned on a side in a direction separating from the second board in the first direction, as the first taper extends toward the first reflective film side, and the second taper is inclined so as to be positioned on a side in a direction approaching the first board in the first direction, as the second taper extends toward the second reflective film side.

According to the aspect described above, since the second taper can apply a force in the outward direction toward the side opposite to the side where the support is positioned to the first taper, an external force pulling the support in the outward direction can be generated. By this, it reduces the possibility of the support being unintentionally bent or deformed.

(5) The above aspect may be such that an inclination angle of the first taper is 45° or more and less than 90° and the inclination angle of the second taper is 45° or more and less than 90°.

According to the aspect, the second taper can efficiently apply a force directed in the outward direction to the first taper.

(6) The above aspect may be such that the first taper is provided in plurality, the second taper is provided in plurality, and At least one of the plurality of first tapers and at least one of the second tapers are in contact with each other.

According to the aspect described above, since the plurality of first tapers and the plurality of second tapers are provided, it is possible to more reliably suppress positional deviation of the second board with respect to the first board.

The present disclosure can be realized in various forms other than the above. For example, it can be realized in the form of a manufacturing method for a wavelength variable interference filter.

What is claimed is:

1. A wavelength variable interference filter comprising:
a first board including a first reflective film and a first bonding region positioned around the first reflective film and
a second board including
a second reflective film that opposes the first reflective film in a first direction via a gap therebetween and
a second bonding region that is positioned around the second reflective film, wherein
the first bonding region has a first flat and a first taper inclined with respect to the first flat,
the second bonding region has
a second flat that opposes the first flat in the first direction and
a second taper that is inclined with respect to the second flat, and
the first board and the second board are bonded to each other by bonding at least the first flat and the second flat to each other in a state where the first taper and the second taper are in contact with each other.

2. The wavelength variable interference filter according to claim 1, wherein
in the first bonding region and the second bonding region, the first taper and the second taper are not bonded to each other, and the first flat and the second flat are bonded to each other.

3. The wavelength variable interference filter according to claim 1, wherein
the first bonding region is formed so as to surround the first reflective film and
the second bonding region is formed so as to surround the second reflective film.

4. The wavelength variable interference filter according to claim 3, wherein
the first board further has a support that is positioned between the first reflective film and the first bonding region, and that elastically deforms to displace the first reflective film and change the size of the gap,
the first taper is inclined so as to be positioned on a side in a direction separating from the second board in the first direction, as the first taper extends toward the first reflective film side, and
the second taper is inclined so as to be positioned on a side in a direction approaching the first board in the first direction, as the second taper extends toward the second reflective film side.

5. The wavelength variable interference filter according to claim 4, wherein
an inclination angle of the first taper is 45° or more and less than 90° and
the inclination angle of the second taper is 45° or more and less than 90°.

6. The wavelength variable interference filter according to claim 1, wherein
the first taper is provided in plurality,
the second taper is provided in plurality, and
at least one of the plurality of first tapers and at least one of the second tapers are in contact with each other.
